(19) United States
(12) Patent Application Publication
(10) Pub. No.: US 2018/0074089 A1
(43) Pub. Date: Mar. 15, 2018

(54) DEVICE AND METHOD FOR MEASURING A ROTATIONAL MOVEMENT OF A ROTATABLE STRUCTURAL COMPONENT, IN PARTICULAR A ROTATIONAL DIRECTION

(71) Applicant: Rolls-Royce Deutschland Ltd & Co KG, Blankenfelde-Mahlow (DE)

(72) Inventor: Jens KESTERING, Berlin (DE)

(21) Appl. No.: 15/702,964

(22) Filed: Sep. 13, 2017

(30) Foreign Application Priority Data
Sep. 15, 2016 (DE) 10 2016 217 687.0

(51) Int. Cl. G01P 3/36; G01P 3/68; F03D 17/00

(52) U.S. Cl. CPC G01P 3/36; F03D 17/00; G01P 3/68

(57) ABSTRACT

A device for measuring a rotational movement, in particular a rotational direction, of a rotatable structural component, in particular a shaft, with a receiver and a pattern carrier that has at least two pattern sites and that can be connected or is connected in such a manner to the rotatable structural component that it can be rotated together with the same about a rotational axis with respect to the receiver, so that at least one pattern site can be turned towards the receiver, wherein the receiver is embodied and configured to detect a pattern site that is turned towards it. Here, at least two receivers are provided, with respectively at least one of the pattern sites being turnable towards them.

### REFERENCE TO RELATED APPLICATION

This application claims priority to German Patent Application No. 10 2016 217 687.0 filed on Sep. 15, 2016, the entirety of which is incorporated by reference herein.

### BACKGROUND

The invention relates to a device for measuring a rotational movement of a rotatable structural component, a turbomachine and a method for measuring a rotational movement of a rotatable structural component.

Such a device comprises a receiver and a pattern carrier acting together with the receiver. The pattern carrier comprises at least two pattern sites. The pattern carrier can be connected or is connected to the rotatable structural component in such a manner that it can be rotated with respect to the receiver about a rotational axis together with the rotatable structural component. Through a rotation of the pattern carrier about the rotational axis, at least one pattern site can be turned towards or away from the receiver, in particular in a periodic manner. The receiver is embodied and configured to detect a pattern site that is turned towards it, i.e. to detect whether a pattern site is turned towards it or not.

Rotational movements of the rotatable structural component measured by such devices can e.g. be used for controlling and monitoring the rotatable structural component. The rotatable structural component can for example be a shaft and/or an axle, in particular a shaft of a turbomachine such as for example a turbomachine that is embodied as an aircraft engine.

The measurement of a rotational movement comprises the measurement of a rotational speed and/or the measurement of a rotational direction.

What is known from practice are for example inductive devices for measuring rotational speeds that are also referred to as a pulse wheel or “phonic wheel”.

DE 10 2007 055 239 A1 describes a device for measuring the rotational speed of a hollow shaft of a jet engine mounted inside a turbine housing. In this device, magnetic flows serve as information carriers. A pattern carrier in the form of a gearing with multiple teeth as pattern sites is arranged at the hollow shaft. A sensor arranged adjacent to the gearing serves as a receiver. The gearing can be rotated with respect to the sensor about the rotational axis of the shaft together with the shaft, with the sensor detecting different magnetic flows if a tooth or a gap of the gearing is facing towards the sensor.

In some applications, in particular in turbomachines, it is desirable to also measure an absolute angular position (in particular with respect to a statics by means of which the rotatable structural component is mounted) and/or a rotational direction of the rotatable structural component, in particular of the shaft, in addition to the rotational speed. For example, one or multiple shafts of the turbomachine can be set into rotation when a turbomachine that is not in operation, for example an aircraft engine, is impinged by wind. Such a situation is also referred to as “wind milling”.

In the event of wind impinging from the rear, it is possible that one or multiple shafts of the turbomachine are set into a rotation counter to the rotation that is intended during operation. Starting up the turbomachine with a fuel supply during this reversed rotation can lead to overheating and damage to the turbomachine. Thus, in the event of strong wind, it is possible that a value corresponding to the minimum number of revolutions of the turbomachine is reached by “wind milling”. If the intended rotational direction of the turbomachine is not observed by a user during the start, for example because no rotational direction display is provided, damage may occur due to overheating particularly to the compressor of the turbomachine.

Further, depending on the application site of the device, the known inductive measurements can be compromised by external electromagnetic influences.

### SUMMARY

There is an objective to provide a better device. The objective is solved through a device with features as described herein.

Accordingly, at least two receivers are provided. The receivers and at least two of the pattern sites are arranged in such a manner that respectively at least one of the pattern sites can be turned towards receivers. At that, amongst each other, the receivers are arranged along an angle extending circumferentially about the rotational axis in a manner offset with respect to one another, while, amongst each other, the pattern sites are arranged along the angle in a manner not offset with respect to one another, or, amongst each other, the pattern sites are arranged along the angle in a manner offset with respect to one another, while the receivers are arranged amongst each other along the angle in a manner not offset with respect to one another, or, respectively amongst each other, the receivers as well as the pattern sites are arranged along an angle extending circumferentially about the rotational axis in a manner offset with respect to one another, wherein the pattern sites have an offset that differs from the offset of the receivers. The receivers are in particular arranged in a positionally fixated manner with respect to one another.

The angle extending circumferentially about the rotational axis is also referred to as the azimuth angle or azimuth. In an arrangement of the pattern sites, it can be provided that each pattern site can be turned towards only exactly one of the receivers.

The use of multiple receivers facilitates particularly precise measurements of the rotational movement of the rotatable structural component. Further, the use of multiple receivers and of the different offsets of the receivers and the pattern sites additionally facilitates the measurement of a rotational direction and of an absolute angular position of the rotatable structural component, in addition to the measurement of a rotational speed of the rotatable structural component (with respect to the receivers). If the rotatable structural component is a shaft of a turbomachine, for example, the receivers are for example fixated at a statics of the turbomachine by means of which the shaft is mounted in a rotatable manner.

The individual receivers and/or the individual pattern sites can be arranged in a manner perpendicularly offset with respect to the rotational axis (e.g. at a distance to one another) in the (radial) direction. Alternatively or additionally, the individual receivers and/or individual pattern sites are arranged so as to be offset in parallel to the rotational axis (e.g. arranged at a distance) with respect to one another in the (axial) direction. For example, the individual receivers and the individual pattern sites are respectively arranged with the same offset with respect to one another. One or multiple receivers and/or one or multiple pattern sites can be arranged respectively substantially at the same radial and/or axial distance to the rotational axis. In this manner, a particularly high measurement accuracy can be achieved.

The at least two pattern sites of each pattern carrier can be arranged according to a first pattern, and the at least two receivers can be arranged according to a second pattern. Here, the first pattern in particular differs from the second pattern. The patterns can respectively extend in a plane perpendicular to the rotational axis. The pattern sites are for example arranged in a plane that is offset with respect to the receivers along the rotational axis. The receivers can detect the pattern sites in the axial direction. Alternatively, the patterns respectively extend in a circumferential plane about the rotational axis, for example. The receivers are arranged radially outside the pattern sites, for example. The receivers can detect the pattern sites in the radial direction. The first pattern of the pattern sites (and/or the second pattern of the receivers) can in particular be provided multiple times along the azimuth angle of the rotational axis, e.g. respectively in an equidistant and/or point-symmetric manner to the point on the rotational axis.

At least some of the pattern sites and/or the receivers are for example respectively arranged along a straight (or substantially straight) line, or along a curved line. For example, the pattern sites are arranged along a curved line as first patterns, and the receivers are arranged along a straight line as second patterns.

Respectively exactly three or more than three (in particular a multiple of three) pattern sites and three or more than three receivers can be provided. Each of the pattern sites can respectively be turned towards at least one or exactly one of the receivers. By using three or more receivers and pattern sites, a high measurement accuracy can be achieved. In that case, the failure of a pattern site or of a receiver does not directly lead to the failure of a function of the device.

The receivers can be embodied and configured to detect an information carrier that passes out form the pattern site that is facing towards it, or that is interacting with the pattern site. The information carrier is e.g. embodied as an (in particular electromagnetic) radiation, as a mass flow, and/or as a sound, in particular as light rays (e.g. visible light rays, infrared light rays, and/or ultraviolet light rays), as an electromagnetic field, as an airflow, and/or as ultrasound. By registering the information carrier, the receiver detects that a pattern site is turned towards it.

According to a further development, the at least two receivers comprise at least one sensor or are operatively connected to at least one sensor. The sensor is embodied for detecting the information carrier. The sensor is in particular embodied in the form of an optical sensor (e.g. in the form of a photo resistor and/or a photodiode), a mass flow meter, a manometer, and/or a microphone. It can be provided that each of the receivers of the device respectively comprises a sensor, e.g. an optical sensor. Alternatively or additionally, the receivers are operatively connected to a common sensor. A sensor can generate a signal, e.g. one that is provided to an analysis unit which can process it.

The device can comprise at least one transmitting unit that is embodied and configured to emit the information carrier (in particular in the direction of at least one receiver). The transmitting unit comprises e.g. at least one light source (e.g. a light-emitting diode or laser diode), air nozzle, and/or sound source. Each of the receivers can respectively be assigned to its own transmitting unit. Multiple or all transmitting units can be arranged according to the same second pattern as the receivers. The second pattern of the transmitting units is e.g. arranged in congruence with the second pattern of the receiver.

The pattern carrier is e.g. arranged between the at least one transmitting unit and the at least two receivers, in particular substantially perpendicular or in parallel to the rotational axis. Alternatively or additionally, a transmitting unit is arranged at the pattern carrier, in particular at the pattern sites of the pattern carrier. Further, at least one transmitting unit, such as for example a light source, is arranged alternatively or additionally at least at one receiver. For example, a mirror or a permanent magnet respectively serves as an alternative pattern site

The pattern carrier is e.g. embodied in the form of a punched disc, in particular in the form of a circular disc arranged coaxially to the rotational axis and/or as a hollow cylinder. The pattern sites are e.g. embodied in a material section of the pattern carrier that extends perpendicular to the rotational axis. Alternatively, the pattern sites are embodied at a section of the lateral surface of the hollow cylinder, in particular at facing sections of the lateral surface. The pattern sites are for example respectively embodied in the form of a hole, in particular as a bore in the pattern carrier. In particular when the pattern sites are embodied as holes, the pattern carrier can be permeable to the information carrier in the area of the pattern sites. For example, the pattern carrier can be permeable to the information carrier only in the area of the pattern sites. Optionally, the pattern carrier can be manufactured from an optically opaque material, or can comprise an optically opaque material. The holes can respectively be embodied with the same size or with different sizes.

In particular pattern sites that are respectively embodied as a hole can extend through the pattern carrier substantially in parallel to the rotational axis. The information carrier (e.g. light rays) can then pass through the holes in parallel to the rotational axis. The information carrier can then be read by the receiver in the direction parallel to the rotational axis. Alternatively, the pattern sites can extend through the pattern carrier at an angle to the rotational axis, e.g. substantially perpendicular to the rotational axis. The information carrier can pass the pattern carrier at an (e.g. substantially perpendicular) angle to the rotational axis. The information carrier can then be read by the receiver in the direction of the (e.g. substantially perpendicular) angle to the rotational axis.

The device can comprise at least one anti-fogging device. For example, the anti-fogging device directs a fluid flow, in particular an air flow, onto at least one of the receivers, in particular onto all receivers, and/or onto at least one or all transmitting units. In this manner, any depositing, for example of liquid or solid floating particles, as a result of condensation and/or desublimation from a surrounding gas on the receiver (and/or on the transmitting unit) can be avoided. In this manner, an undisturbed function of the device can be facilitated. In addition, the fluid/air flow can cool the receivers and/or transmitting units, whereby a flawless function and/or a maximally long service life of the receiver can be ensured.

The objective is also achieved by a turbomachine with features as described herein.

The turbomachine can in particular be embodied in the form of an aircraft turbine or a stationary turbine plant, and can comprise one or multiple shafts and one or multiple devices according to any embodiment described herein. Here, the pattern carrier of the device is connected in particular in a torque-proof manner to the shaft, e.g. to a low-pressure shaft, a medium-pressure shaft, and/or a high-pressure shaft of the turbomachine.

With the help of the device, the rotational speed as well as the absolute angular position and the rotational direction of one or multiple shafts of the turbomachine can be measured in a reliable manner. By measuring the rotational direction of the shaft or the shafts of the turbomachine, a reverse rotational direction can be detected. If desired, a correction of the rotational direction can be performed before ignition in order to avoid any damage.

At least one device can be arranged at the turbomachine in the area of a bearing site of the shaft. At the bearing site, the shaft is e.g. mounted at a statics of the turbomachine in a rotatable manner. In the area of the bearing sites, a fixation of the pattern carrier of the device at the shaft and of the receivers at the statics of the turbomachine can be integrated particularly advantageously.

The objective is also achieved through a method for measuring a rotational movement of a rotatable structural component, in particular a rotational speed, a rotational direction and/or an absolute angular position, with features as described herein.

What is used in the method is a receiver and a pattern carrier having at least two pattern sites and being connected in such a manner to the rotatable structural component, in particular a shaft, that it can be rotated together with the same about a rotational axis with respect to the receiver, so that the pattern site can be turned towards the receiver, wherein the receiver detects a pattern site when it is turned towards it.

Here, at least two receivers are provided, with at least one of the pattern sites being respectively turnable towards them, wherein the receivers or the pattern sites are arranged along an angle circumferentially extending about the rotational axis in a manner offset with respect to one another, or are arranged with a differing offset along the angle in a manner offset with respect to one another, wherein in particular a device according to any embodiment described can be used.

### BRIEF DESCRIPTION OF THE DRAWINGS

The invention is explained in connection with the exemplary embodiments shown in the Figures.

FIG. 1 shows a schematic rendering of an aircraft turbine as an embodiment of a turbomachine.

FIG. 2 shows a schematic rendering of a device for measuring a rotational movement of a structural component rotatable about a rotational axis rotatable in a planar sectional view.

FIG. 3 shows, in a top view along the rotational axis, a schematic rendering of a pattern carrier of the device according to FIG. 2 that is embodied in the form of a punched disk.

FIG. 4 shows a schematic rendering of an arrangement of multiple receivers of the device according to FIGS. 2-3 in a top view along the rotational axis.

FIG. 5 shows a schematic rendering of exemplary measurement values of the receivers of the device according to FIGS. 2-4.

FIG. 6 shows a schematic rendering of an anti-fogging appliance of the device according to FIGS. 2-5.

FIGS. 7A-7C show different schematic renderings of alternative arrangements of the punched disc of the device according to FIGS. 2-6 at the rotatable structural component.

FIG. 8 shows a schematic rendering of a device for measuring a rotational movement of a structural component that is rotatable about a rotational axis in a cut-open view according to FIG. 2.

FIG. 9 shows a schematic rendering of a device for measuring a rotational movement of a structural component that is rotatable about a rotational axis in a perspective view.

FIG. 10 shows a schematic rendering of exemplary measurement values of the receivers of the device according to FIGS. 2-4, 8 and 9 in the case that one or two receivers fail.

FIG. 11 shows a flow chart for a method for measuring a rotational movement.

### DETAILED DESCRIPTION

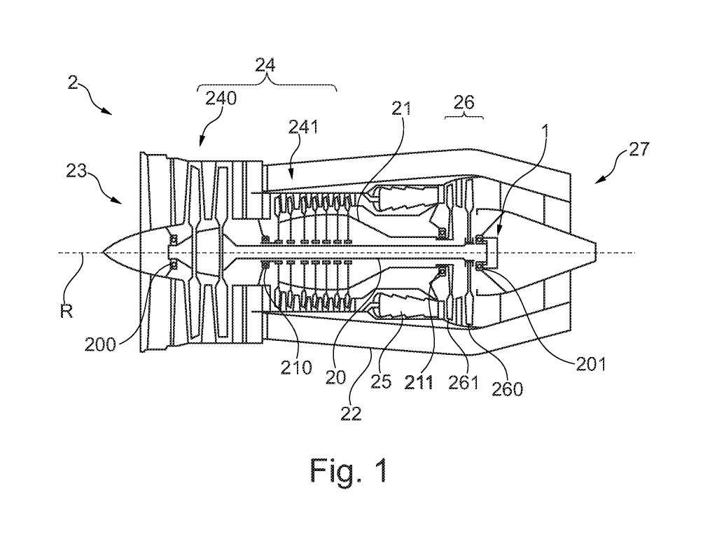

FIG. 1 shows a turbomachine in the embodiment of an aircraft turbine 2 for an aircraft. As rotatable structural components, the aircraft turbine 2 comprises multiple, in the present case two, shafts 20, 21 that are rotatable about a common rotational axis R. The shafts 20, 21 are arranged inside a housing 22 of the aircraft turbine 2. The housing 22 defines an air intake 23 of the aircraft turbine 2.

An air flow flows into the aircraft turbine 2 through the air intake 23. The aircraft turbine 2 has an axial through-flow direction. The through-flow direction extends substantially along the rotational axis R of the shafts 20, 21. Behind the air intake 23, the aircraft turbine 2 comprises, as viewed substantially in through-flow direction, a compressor 24, a combustion chamber 25, a turbine 26, and a nozzle 27.

In the present case, the aircraft turbine 2 is embodied with two shafts. One of the shafts 20, 21 serves as a low-pressure shaft 20, the other as a high-pressure shaft 21. Fixedly arranged at the low-pressure shaft 20 are a low-pressure compressor 240 of the compressor 24 as well as a low-pressure turbine 260 of the turbine 26. Fixedly arranged at the high-pressure shaft 21 are a high-pressure compressor 240 of the compressor 24 as well as a high-pressure turbine 260 of the turbine 26.

The aircraft turbine 2 works in a per se known manner. The low-pressure compressor 240 and the high-pressure compressor 241 compress the inflowing air flow, and conduct it into the combustion chamber 25 for the purpose of combustion. The tension in the hot combustion gases that exit the combustion chamber 25 is reduced in the high-pressure turbine 261 and in the low-pressure turbine 260 before being discharged through the nozzle 27. The nozzle 27 ensures residual pressure release of the exiting hot combustion gases, as well as intermixing with secondary air. At that, the exiting air flow is accelerated, whereby thrust is created.

The low-pressure turbine 260 drives the low-pressure compressor 240 via the low-pressure shaft 20. The high-pressure turbine 261 drives the high-pressure compressor 241 via the high-pressure shaft 21.

Both shafts 20, 21 are mounted by means of suitable bearings 200, 201, 210, 211 so as to be rotatable about the rotational axis R with respect to an engine statics. The engine statics is fixedly connected to the housing 22. The engine statics can be fixedly connected to the aircraft

According to FIG. 1, the low-pressure shaft 20 and the high-pressure shaft 21 have a front bearing 200, 210 at their respective ends that are facing towards the air intake 23. The front bearings 200, 210 are respectively embodied as ball bearings. At their ends that are respectively facing towards the air outlet 27, the low-pressure shaft 20 and the high-pressure shaft 21 comprise a rear bearing 201, 211. The rear bearings 201, 211 are respectively embodied as rolling bearings.

The high-pressure shaft 21 is embodied as a hollow shaft. The low-pressure shaft 20 is arranged inside the high-pressure shaft 21.

For determining a rotational movement of the low-pressure shaft 20, namely a rotational speed as well as an absolute angular position and a rotational direction, the aircraft turbine 2 comprises a device 1, which is rendered only in a schematic manner in FIG. 1. In the present case, the device 1 is arranged in the area of the rear bearing 201 of the low-pressure shaft 20.

The device 1 will be explained in more detail based on the following Figures.

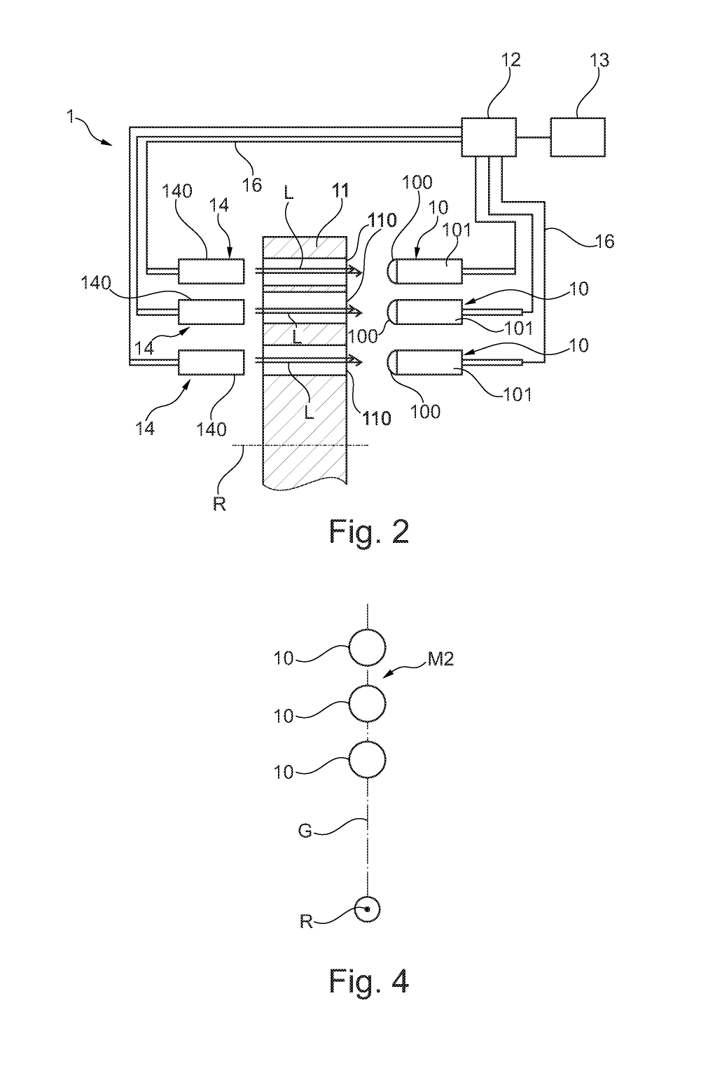

According to FIG. 2, the device 1 comprises a pattern carrier 11, multiple receivers 10 and multiple transmitting units 14. At that, respectively one of the receivers 10 is assigned to exactly one of the transmitting units 14. In the shown exemplary embodiment, the device 1 comprises exactly three receivers 10 and exactly three transmitting units 14.

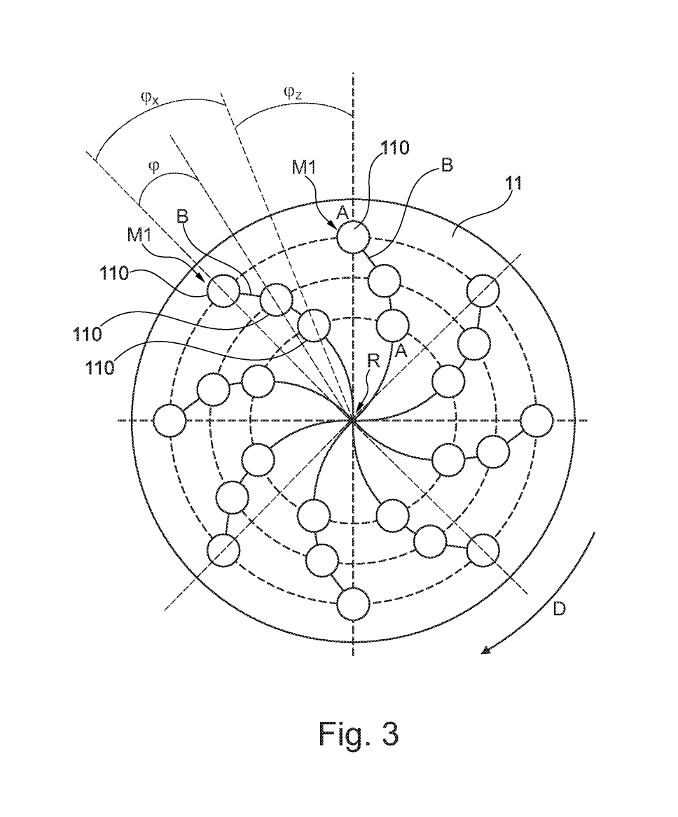

As is illustrated in particular FIG. 3, the pattern carrier 11 is embodied in the form of a circular punched disc 11 in the shown exemplary embodiment. The punched disc 11 is arranged concentrically to the rotational axis R. The punched disc 11 is connected in a torque-proof manner to the low-pressure shaft 20.

In the present case, the receivers 10 comprise respectively one optical sensor 101, e.g. respectively in the form of a photo resistor and/or a photodiode. For an efficient light yield, a lens 100 is respectively arranged upstream of each of the sensors 101, for example in the form of respectively one converging lens.

The transmitting units 14 respectively comprise a light source 140, for example in the form of a light-emitting diode and/or a laser diode. The light sources 140 emit light rays L as information carriers, which can be detected by the receivers 10. Each of the transmitting units 14 and the respectively associated receiver 10 are aligned with respect to one another. Light rays are not disturbed by external electromagnetic signals and are therefore particularly suitable as information carriers.

The receivers 10 and the transmitting units 14 are arranged so as to be mounted fixedly with respect to one another, for example by being attached at the engine statics and/or a common carrier. The (in the present case tree) transmitting units 14 are substantially aligned in parallel to one another. The light rays L that are respectively emitted towards the receivers 10 extend substantially in parallel to one another (at least partially). The light rays L emitted by the transmitting units 14 towards the receivers 10 extend substantially perpendicular to the rotational axis R and intersect the rotational axis R.

The punched disc 11 is arranged between the transmitting units 14 and the receivers 10. The punched disc 11 is rotatable about the rotational axis R. For this purpose, the punched disc 11 is connected to the low-pressure shaft 20 in a torque-proof manner. The punched disc 11 is arranged at the low-pressure shaft 20 in such a manner that it can be rotated together with the low-pressure shaft 20 about the rotational axis R. For example, the punched disc 11 is embodied in one piece with the low-pressure shaft, or is attached to the same in a suitable manner, for example by means of a screw connection.

As is in particular illustrated in FIG. 3, multiple pattern sites in the form of continuous holes 110 are provided in the punched disc 11. The holes 110 extend substantially in parallel to the light rays L emitted by the transmitting units 14 through the punched disc 11 towards the receivers 10. Each of the holes 110 is assigned to exactly one of the receivers 10. The holes 110 are embodied in a circular manner and respectively have the same size.

If a hole 110 is arranged between the associated transmitting unit 14 and the associated receiver 10 (as a result of a corresponding position due to the rotation of the punched disc 11), the light rays L emitted by the transmitting unit can pass the hole 110. The transmitting unit 14, the hole 110 and the receiver 10 are then substantially arranged on a straight line extending in parallel to the rotational axis R. On the side of the punched disc 11 that is facing towards the transmitting unit 14, the light rays L exit from the hole 110 and are detected by the receiver 10.

If no hole 110 is arranged between the associated transmitting unit 14 and the associated receiver 10, the light rays L of the transmitting unit 14 cannot pass the punched disc 11. In that case, the associated receiver 10 does not detect the light rays L.

Respectively three holes 110 of the punched disc 11 are arranged according to a first pattern M1 with respect to one another. The first pattern M1 describes a curved line B. Thus, respectively three holes 110 are arranged along the curved line B. The curved line B intersects the rotational axis R. In the present case, the curved line B is embodied in the form of a circular arc, by way of example. In general, the curved line B can be embodied as a partial section of an ellipse. The curved line B can be embodied in such a manner that the holes 110 (or in general the pattern sites) of a first pattern M1 are arranged with an irregular angular offset with respect to one another along the azimuth.

Alternatively to a curved line B, the first pattern M1 can also be embodied in such a manner that it describes a straight line. The straight line intersects the rotational axis R or extends in such a manner that it does not intersect the rotational axis.

According to a further possible alternative, the first pattern M1 is embodied in such a manner that the same offset is provided along the azimuth or substantially the same offset is provided along the azimuth between some or all adjacent holes (or pattern sites, in general) of the first pattern M1.

The first pattern M1 is repeated several times along an azimuth that extends circumferentially about the rotational axis R perpendicular to the rotational axis R, in the present case eight times. Respectively a plurality of holes 110 (in the present case respectively eight) is arranged in a circular manner at multiple (in the present case three) different radiuses to the rotational axis R. The circles of the holes 110 are arranged along the azimuth in a manner offset with respect to one another.

Respectively two holes 110 that belong to a common first pattern M1 (meaning that they are arranged on a common curved line B at a distance from one another) are arranged along the azimuth about an azimuth angle φ in a manner offset with respect to one another. For example, an offset along the azimuth between two adjacent holes 110 belonging to the same first pattern M1 can correspond to up to approximately a tenth of a diameter, or approximately a tenth of a diameter up to a diameter of those holes 110, in particular less than half a diameter, or approximately a quarter to a half of a diameter of those holes 110.

It can be provided that all holes 110 belonging to a common first pattern M1 are arranged so as to be respectively offset with respect to one another by the same azimuth angle φ. Alternatively, the azimuth angles φ can be different. For example, the azimuth angle φ between the radially outer hole 110 and the radially central hole 110 is larger or smaller than the azimuth angle between the radially central hole and the radially inner hole 110. As shown in FIG. 3, in total the holes 110 of a first pattern M1 span an azimuth angle φₓ (wherein in the present case the azimuth angle refers to the center points of the holes 110). This angle φₓ can also be referred to as the pattern width φₓ. The pattern width φₓ is larger than the azimuth angle φ around which two holes 110 are arranged adjacent to one another along the azimuth (or, generally speaking, two pattern sites are arranged adjacent to one another along the azimuth) in a manner offset with respect to one another: φₓ>φ.

Two adjacent first patterns M1 can be arranged along the azimuth so as to be offset with respect to one another by an azimuth angle φ_{z} (as shown in FIG. 3). The azimuth angle φ_{z} can also be referred to as the pattern distance φ_{z}. The pattern distance φ_{z} is larger than the pattern width φₓ: φ_{z}>φₓ.

FIG. 2 shows a view according to a section A-A along a curved line B that is indicated in FIG. 3. If the punched disk 11 is aligned respectively, light rays L of each of the transmitting units 14 can pass an associated hole 110 and be detected by an associated receiver 10.

As illustrated in FIG. 4, the in the present case three receivers 10 of the device 1′ are arranged according to a second pattern M2. The second pattern M2 differs from the first pattern M1. In the present case, the second pattern M1 describes a straight line G. The straight line G intersects the rotational axis R. Alternatively, it can be provided that the straight line G does not intersect the rotational axis R.

The receivers 10 (in the present case tree) that are arranged according to the second pattern M2 are arranged substantially at the same radial distances to the rotational axis R as the pattern sites that belong to a common first pattern M1, and in the present case are embodied in the form of holes 110.

Each of the holes 110 is assigned to a pair of a transmitting unit 14 and a receiver 10. In the present case, all those holes 110 are assigned to a pair that are arranged at substantially the same radial distance to the rotational axis R as the pair of transmitting unit 14 and the receiver 10.

As a result of a rotation of the punched disc 11 about the rotational axis R, the hole 110 can be positioned in congruence with the associated transmitting unit 14 and the associated receiver 10. If the hole 110 is positioned in congruence with respect to the associated transmitting unit 14 and the associated receiver 10, the light rays L emitted by the transmitting unit 14 can exit through the hole 110 on that side of the hole 110 that is facing towards the receiver 10. The receiver 10 can detect the light rays L exiting from the associated hole 110.

Apart from the hole 110, the punched disc 11 is optically opaque (or, generally speaking, substantially unpassable for the information carrier). If none of the holes 110 that are assigned to a receiver 10 are at least partially in congruence with the receiver 10, the receiver 10 cannot detect the light rays L emitted by the associated transmitting unit 14.

A rotation of the punched disc 11 about the rotational axis R with respect to the transmitting units 14 and the receivers 10 puts the holes 110 of a common first pattern M1 in congruence with their respectively associated transmitting units 14 and receivers 10 at staggered time intervals.

Via suitable electrical signal lines 16, the transmitting units 14 and the receivers 10 are respectively in operative connection with an analysis unit 12 of the device 1. The receivers 10 send signals S1-S3 to the analysis unit 12. The analysis unit 12 is e.g. embodied in the form of a microprocessor or a computer. In particular, the analysis unit 12 is an electronic engine control (EEC) or an engine monitoring unit (EMU) of the aircraft turbine 2.

Alternatively, the second pattern M2 can describe a curved line. Thus, the receivers 10 are arranged along the curved line. The curved line can intersect the rotational axis R. For example, the curved line B can be embodied in the form of a circular arc. In general, the curved line can be embodied as a partial section of an ellipse. The curved line can be embodied in such a manner that the receivers 10 are arranged with an irregular angular offset along the azimuth with respect to one another.

According to another alternative, the second pattern M2 is embodied in such a manner that the same offset along of the azimuth or substantially the same offset along the azimuth is provided between some or all adjacent receivers 10.

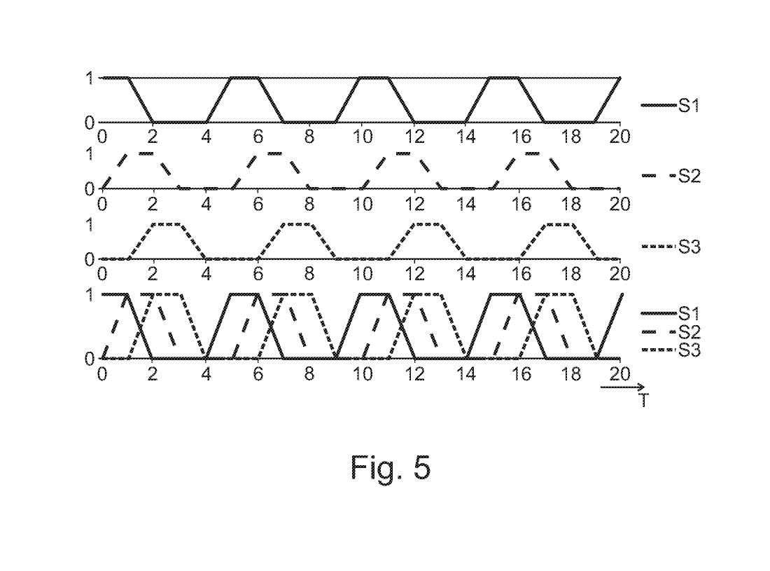

FIG. 5 schematically shows the temporal development of the signals S1-S3 of the three receivers 10 shown in FIGS. 2 and 4 during a rotation of the punched disc 11 about the rotational axis R along a rotational direction D (clockwise) that is indicated in FIG. 3. Here, the time T is indicated on the x-axis, with the y-axis respectively showing the signal strength of the signals S1-S3.

A first signal S1 comes from the radially inner receiver 10. A second signal S2 comes from the radially central receiver 10. A third signal S3 comes from the radially outer receiver 10.

As soon as a hole 110 is positioned between the associated pair of transmitting unit 14 and receiver 10 as a result of the rotation of the punched disc 11, the receiver 10 begins receiving light rays L of the transmitting unit 14, and sends a signal S1-S3 that differs from zero. The signal S1-S3 increases along a rising edge, until the hole 110 is positioned in the greatest possible congruence with the receiver 10. In the shown example, the light rays L are bundled more tightly than the diameter of the hole 110, so that the signal S1-S3 remains approximately constantly on a maximum value over a period of time. As soon as the congruence of the hole 110 with the receiver 10 decreases again due to a further rotation of the punched disc 11, the signal S1-S3 decreases down to zero along a falling edge. As soon as a next hole 110 assigned to the receiver 10 arrives, a new period of the signal curve begins. The number of periods per time unit determines the frequency of the signals S1-S3.

In the bottom area of FIG. 5, the signals S1-S3 of the three receivers 10 are shown in a superimposed manner. The rotation of the punched disc 11 along the rotational direction D at first leads to the increase of the first signal S1, then of the second signal S2, and then of the third signal S3.

Since the holes 110 according to FIG. 3 partially overlap along the azimuth, the signals S1-S3 of adjacent holes 110 can be different from zero at the same point in time. For example, scattered light from an edge of a hole 110 can also contribute to that.

As becomes clear based on FIG. 5, the adjacent first patterns M1 have such a pattern distance φ_{z} that the signals S1-S3 of all receivers 10 substantially fall to zero between the first patters M1. A signal pause of the signals S1-S3 of all receivers 10 is created between two adjacent first patterns M1. In the signal pause, none of the signals S1-S3 of the receivers 10 takes on its maximum value. The signal pause is longer than the distance between the transition from the maximum value to the falling edge of the first signal S1, and the transition from the rising edge to the maximum value of the third signal S3.

The analysis unit 12 analyzes the signals S1-S3 received by the receivers 10. Based on the frequency of the signals S1-S3, the analysis unit 12 determines the rotational speed of the der punched disc 11 and thus of the low-pressure shaft 20 (generally speaking, of the rotatable structural component connected therewith). Optionally, the analysis unit 12 respectively determines the frequency of the individual signals S1-S3 and calculates the mean value of the frequencies. Mean value formation can increase the measuring accuracy.

Based on the order of the periods of the individual signals S1-S3, the analysis unit 12 determines the rotational direction of the punched disc 11 and thus of the low-pressure shaft 20 (generally speaking, of the rotatable structural component connected therewith). Should the signal strength of the third signal S3 be increased before the signal strength of the second and of the first signal S2, S1, the analysis unit 12 would determine that the punched disk 11 rotates counter to the rotational direction D (counterclockwise).

In case the central receiver 10 fails, the rotational direction can still be determined through the provided signal pause based on only the signals S1 and S3 of the radially inner and of the radially outer receivers 10. Thus, the device 1 can be used as a so-called BITE (Built In Test Equipment). For this purpose, the punched disc 11 is set into rotation. Here, the function of the punched disc 11, the transmitting units 14 and the receiver 10 can be checked.

The analysis unit 12 is operatively connected to the display unit 13 for displaying the determined rotational speed, the absolute angular position, and/or the rotational direction.

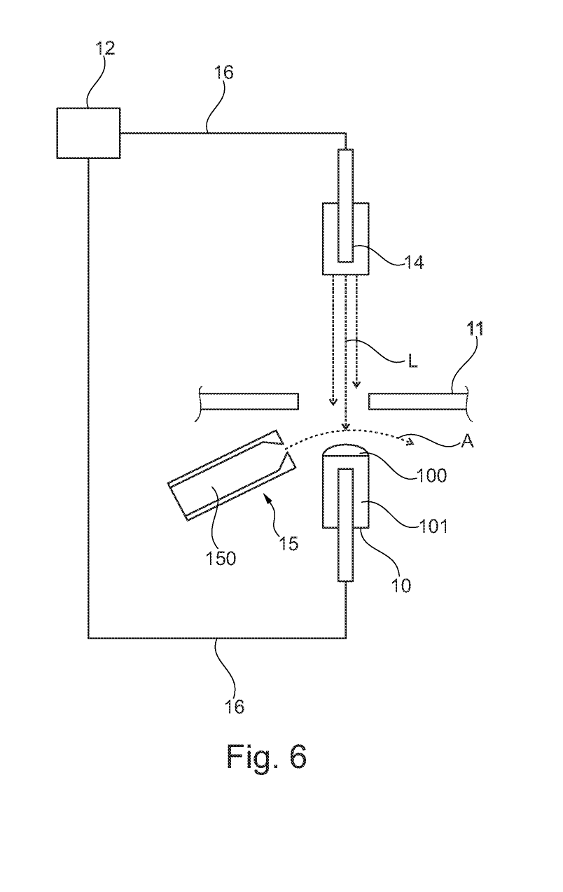

FIG. 6 shows an anti-fogging device 15 with an air nozzle 150, which is not shown in FIGS. 1-5. The air nozzle 150 is arranged adjacent to one or multiple of the receivers 10.

The air nozzle 150 blows an air flow A via the receiver 10, more specifically via the lens 100 of the receiver 10. The air flow A hinders floating particles of the gas surrounding the receiver 10 from depositing at the lens 100, in particular an oil mist of the aircraft turbine 2. Further, the air flow A avoids any condensation and/or desublimation of components of the gas surrounding the receiver 10 at the lens 100.

Thus, the air nozzle 150 at least mostly avoids fogging of the lens 100, so that the function of the receiver 10 is substantially not compromised by fogging.

Optionally, air baffles and/or flow channels can be provided in the area of the air flow A. In this manner, any influence by carried-along oil mist (as in the type of a jet pump) can be avoided or at least minimized.

Optionally, the air nozzle 150 can be adjusted (for example with respect to the blow direction of the air flow A and/or the strength of the air flow A), and for this purpose can be in operative connection with the analysis unit 12 and can be controlled by the analysis unit 12, for example.

Bleed air can serve as the air for the air flow A, for example. The air for the air flow A is for example extracted from a compressor stage 240, 241 and supplied to the air nozzle 150. In particular the air for the air flow A is provided with an overpressure.

A common air nozzle 150 can be provided for all receivers 10. Alternatively, an air nozzle 150 can be provided for each of the receivers 10. Also, one or multiple air nozzles 150 can be provided for one transmitting unit 14 or multiple transmitting units 14.

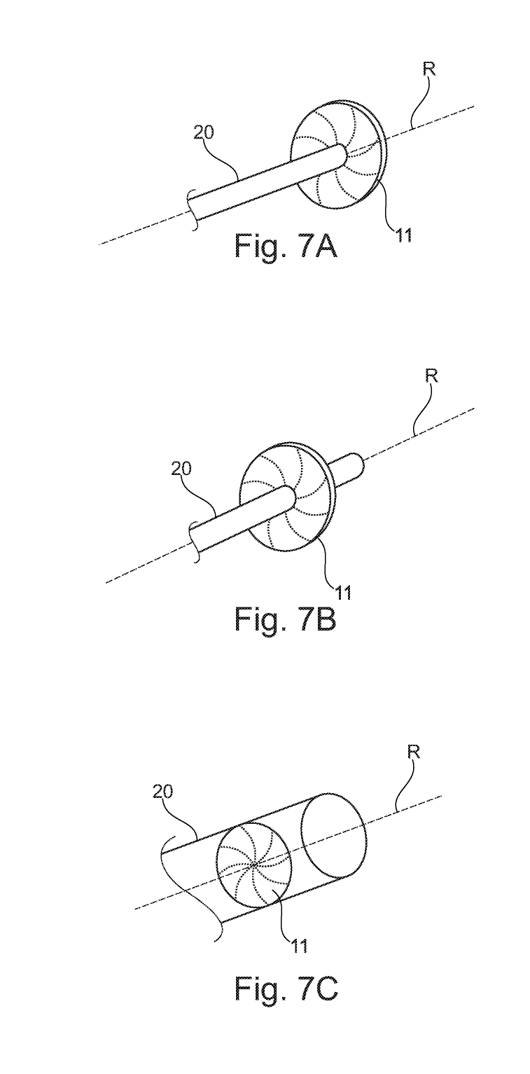

FIGS. 7A-7C show different exemplary possibilities for arranging the punched disc 11 at the low-pressure shaft 20. An arrangement at the high-pressure shaft 21 is also possible in a corresponding manner either alternatively or additionally. For example, the punched disc 11 is fitted at an axial end of the low-pressure shaft 20 according to FIG. 7A. Alternatively, the punched disc 11 comprises a central recess and surrounds the low-pressure shaft 20 coaxially, as is shown in FIG. 7B. For example, the punched disc 11 is embodied as a flange. According to a further alternative shown in FIG. 7C, the punched disc 11 is arranged inside the low-pressure shaft 20. At least in the latter example, the low-pressure shaft 20is embodied in the form of a hollow shaft.

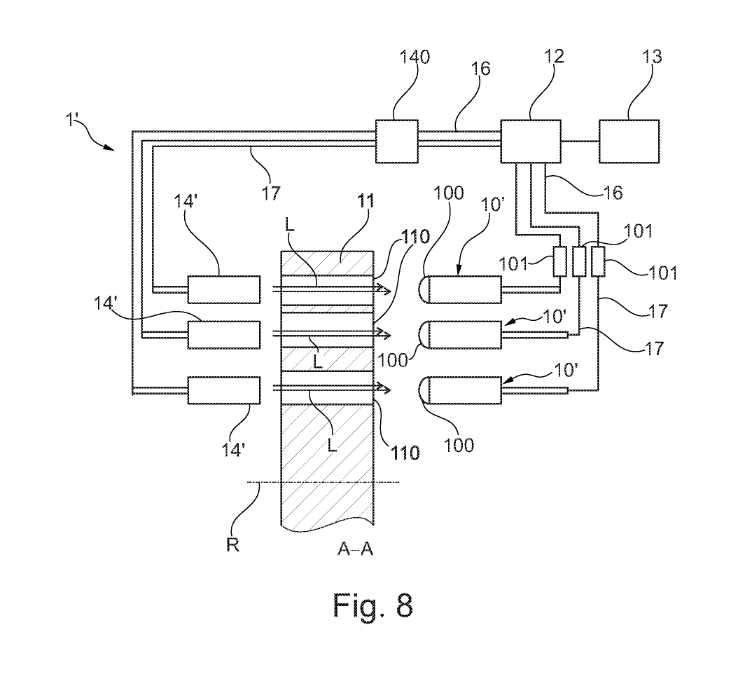

FIG. 8 shows an exemplary embodiment of a device 1′ in which the embodiment of the transmitting units 14′ and receivers 10′ differs with respect that of the exemplary embodiment according to FIG. 2. Otherwise, the exemplary embodiment of FIG. 8 corresponds in particular to the exemplary embodiment shown in FIG. 2.

A difference to the device 1 according to FIGS. 2A and 2B is that, according to FIG. 3, no optical sensors are arranged directly at the receivers 10′. Instead, the receivers 10′ collect the light rays L that are falling in (via the lens 100), and guide them into respectively one optical waveguide 17, for example an optical fiber cable. The optical waveguides 17 are respectively connected to one optical sensor 101. The optical sensors 101 are arranged at a distance from the receivers 10. For example, the optical sensors 101 are arranged adjacent to the analysis unit 12 and/or in an area of the aircraft turbine 2 where a lower temperature is present as compared to the area of the receivers 10, and/or in an area that is not impinged by oil mist of the aircraft turbine 2.

Alternatively, only one optical sensor 101 is provided for all receivers. An allocation of the signals of the individual receivers can be realized by means of coding, for example by color coding (for example based on differently colored components of the individual receivers 10 and/or optical waveguides 17).

The transmitting units 14′ according to FIG. 8 are embodied as radiating units that are respectively connected via an optical waveguide 17 to a light source 140 that is arranged at a distance. Possible arrangements of the light source 140 correspond to the possible arrangements of the optical sensors 101. For example, the light source 140 is arranged adjacent to at least one optical sensor 101. Alternatively, each transmitting unit 14′ is connected to a separate light source via the respective optical waveguide 17.

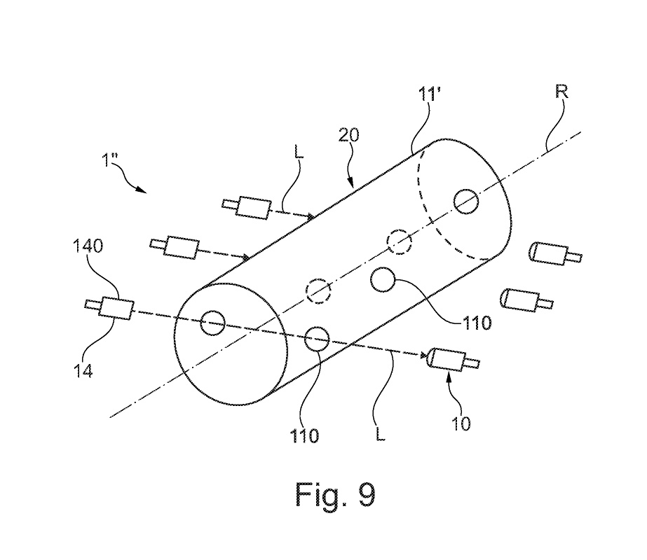

FIG. 9 shows an exemplary embodiment of a device 1″ for measuring the rotational movement of the rotatable structural component, here of the low-pressure shaft 20.

In the device 1″ according to FIG. 9, the pattern carrier 11′ is embodied by a section of the rotatable structural component, here the low-pressure shaft 20. Multiple (three) transmitting units 14 emit information carriers in the form of light rays L towards respectively associated receivers 10. The light rays L of the transmitting units 14 emitted towards the receivers 10 extend in parallel with respect to one another.

The pattern carrier 11′ is arranged between the transmitting units 14 and the receivers 10. The rotational axis R extends between the transmitting units 14, on the one hand, and the receivers 10, on the other.

The light rays L of the transmitting units 14 emitted towards the receivers 10 extend substantially perpendicular to the rotational axis R.

The pattern carrier 11′ has a circular cylindrical shape, in the present case a hollow-cylindrical shape with a circumferential shell surface. Multiple pattern sites in the form of holes 110 are embodied in the shell surface of the pattern carrier 11′. A further hole 110 is embodied on a side of the shell surface that is facing towards each hole 110. A straight line between facing holes 110 substantially intersects with the rotational axis R, in particular in a perpendicular manner. If, due to the rotation of the pattern carrier 11′ about the rotational axis R, both facing holes 110 are arranged along the light rays L from one of the transmitting units 14, the light rays L can pass the pattern carrier 11′ through both holes 110, and are detected by the assigned receiver 10. If the facing holes 110 are rotated further, so that they are no longer arranged along the light rays L, they cannot pass the pattern carrier 11′.

Multiple respectively facing pairs of holes 110 and associated transmitting units 14 and receivers 10 are arranged along the rotational axis R. The transmitting units 14 and the receivers 10 are aligned in parallel with respect to one another. The facing pairs of holes 110 that are arranged along the rotational axis R next to one another are arranged in a manner offset with respect to one another along the azimuth angle (the angle extending circumferentially about the rotational axis R). A rotation of the pattern carrier 11′ leads to the individual receivers 10 successively detecting the light rays L.

As for the analysis of the associated signals, reference is made to the above description in connection with FIGS. 2-5.

As has been already explained above in connection with FIG. 5, providing three or at least three receivers 10 (and in particular the same number of associated transmitting units 14) can yield measurement values even if one of the receivers 10 or one of the transmitting units 14 fails. This characteristic is advantageous particularly in safety-critical applications, for example in aircraft turbines 2.

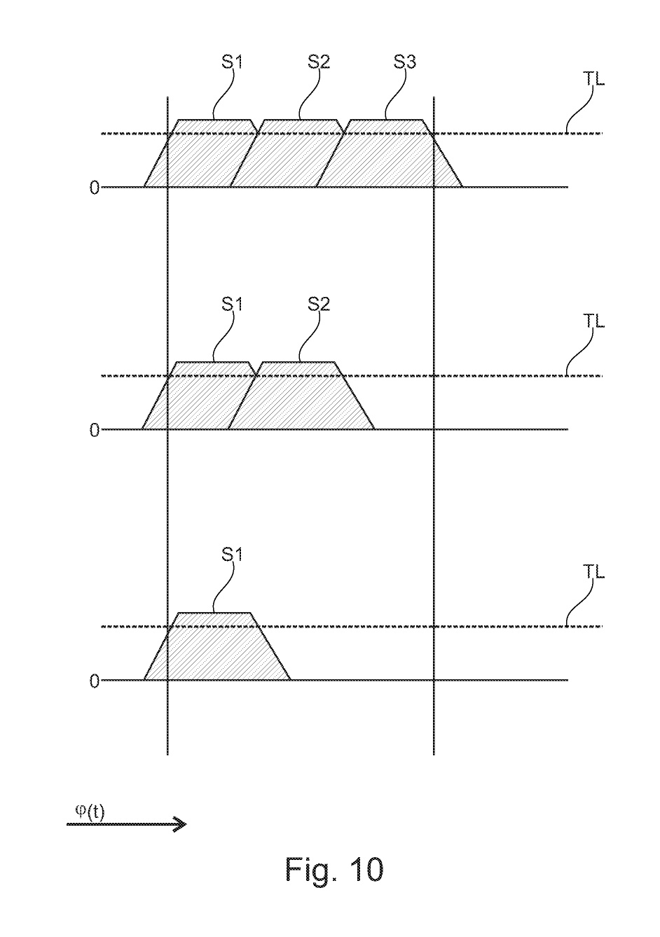

Similar to FIG. 5, FIG. 10 shows the signals S1-S3 measured by the three receivers 10, wherein here only the signals S1-S3 of a single first pattern M1 are shown to provide a clearer illustration. Further, a trigger level TL is indicated in FIG. 10. If a signal S1-S3 of one of the receivers exceeds the trigger level TL, the analysis unit 12 detects the signal S1-S3 as valid. For instance, the analysis unit 12 measures the time interval in which the signal S1-S3 is larger than the trigger level TL, and/or the time interval between exceeding the trigger level TL of the signal S1 of one of the receivers 10 to exceeding the trigger level TL of the next signal S1, S2, S3 of the same receiver 10, or one of the other receivers 10.

In the top part of FIG. 10, the fully functional state is shown in which all receivers 10 provide signals S1-S3. Based on the measured signals S1-S3, the analysis unit 12 can determine the rotational speed, the rotational direction and the absolute angular position of the shaft 20 with a high degree of precision. For the measurement of the absolute angular position, it can be provided that only exactly one first pattern M1 is embodied at the pattern carrier 11, or that not the same angular offset is embodied between all of the multiple first patterns M1.

In order to minimize or determine measurement errors, the analysis unit 12 can form multiple different pairs of receivers 10 (more precisely, the respective signals S1-S3 of the receivers 10) and can determine a value, e.g. for the rotational speed (and/or the rotational direction). The thus separately determined values can then be compared to each other. Deviations between the values can be used to determine errors. Optionally, mean values of the multiple values can be formed. Alternatively or additionally, the analysis unit 12 can determine the rotational speed based on the first signal S1, based on the second signal S2, and based on the third signal S3 respectively independently of one another. These values can then in turn be compared to each other in order to determine and to minimize measurement errors.

The individual holes 110 (pattern sites) in the pattern carrier 11 are arranged in such a manner that they overlap with each other as viewed in the radial direction. What results in this manner are developments of signals S1-S3 as shown in FIG. 10. More specifically, in the regarded time period, at least one of the signals S1-S3 always exceeds the trigger level TL. In this manner, a particularly large angle coverage is obtained, so that analyzable signals S1-S3 are present for a large part of the time, or even at all times. The device can thus have a particularly short response time.

In the middle of FIG. 10, the state with a malfunctioning or temporarily deactivated receiver 10 is shown, here the receiver 10 with the third signal S3. In this state, it is possible to measure the rotational speed and the rotational direction. For the rotational speed, the signals S1, S2 of two receivers can be used, which still allows for a redundant measurement. Measurements of the absolute angular position of the shaft 20 can still be performed, e.g. by interpolation between two measuring points. However, this may lead to a reduction of the measurement precision, e.g. if an acceleration takes place in the regarded time window.

In the lower part of FIG. 10, the state with two malfunctioning or temporarily deactivated receivers 10 is shown, here the receivers 10 with the second and the third signal S2, S3. In this state, the rotational speed can still be measured, e.g. based on the length of time in which the first signal S1 exceeds the trigger level TL, or based on the length of time following the exceeding or falling below the trigger level TL to the next exceeding of the trigger level TL. However, a measurement of the rotational direction is no longer possible; for a measurement of the absolute angular position of the shaft 20 interpolation between two measurements can again be performed, which may be associated with a reduced measurement accuracy.

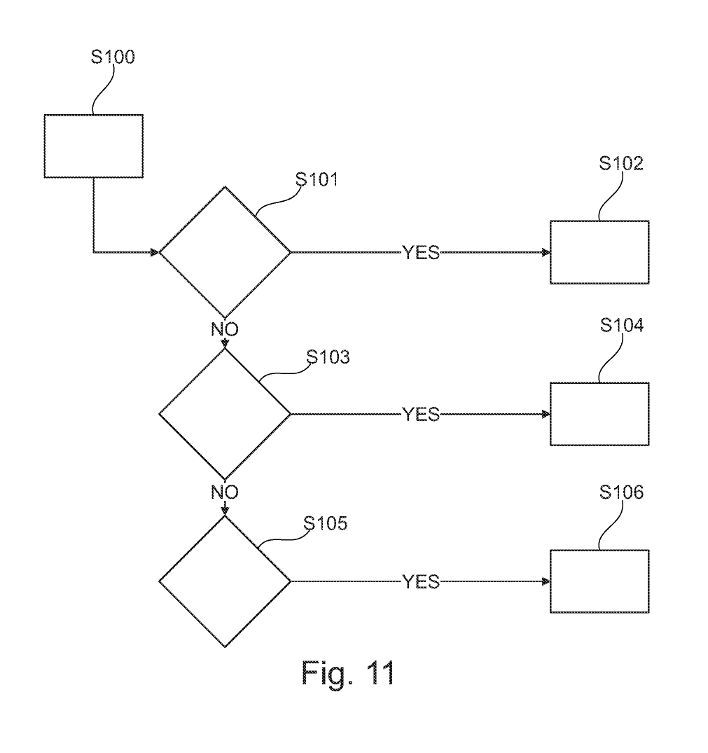

FIG. 11 shows a flow chart for a method for measuring a rotational movement by using one of the devices 1, 1′, 1″ described herein.

At first, in step S100, one of the devices 1, 1′, 1″ described herein is provided.

In step S101 it is examined whether a measurement only of the rotational speed and only for non-safety-critical applications is required. If that is the case, it is considered sufficient if only one of the receivers 10 is active. The other receivers 10 can be turned off or can stay turned off, e.g. to save energy. Then, in step S102 a measurement of the rotational speed can be performed by means of the signal S1-S3 of the one receiver 10. For this purpose, the pattern carrier 11, 11′ is rotated together with the shaft 20, 21 relative to the receivers 10 and the signal S1-S3 of the receiver 10 is detected.

Otherwise, it is examined in step S103 whether a measurement only of the rotational speed and/or rotational direction (optional for safety-critical applications) is required. If that is the case, a measurement is performed by means of two receivers 10 in step S104. The other receiver 10 can be turned off or can remain turned off. If on of the three receivers 10 is defective, the measurement can still be performed with the other two receivers 10.

Otherwise, it is examined in step S105 whether a precise measurement of the absolute angular position is required. In that case, a measurement with three (or at least three) receivers 10 is performed in step S106. Otherwise, e.g. an error message can be output.

The measurement performed in step S106 d (or, in general, each measurement performed by means of at least three receivers 10) can be combined with other time-based measurements for minimizing measurement errors, e.g. with measurements of one additional device for measuring a rotational movement, in particular a device that detects a certain angular position of the shaft 20, 21. In particular, it is possible, to supply the measurement performed in step S106 to a TSA (Time-Domain Synchronous Averaging) and/or a FFT (Fast Fourier Transformation) algorithm. By using the TSA, geometry-related (in particular rotational angle correlated) oscillations or vibrations can be better separated from other dynamic (e.g. torsional oscillations) and asynchronously or stochastically occurring interferences, since they are not represented in the time window but in the twist angle in that case. A post-processing by means of FFT then yields a clear image of the orders with reduced sidebands, which occur due to signal interference.

In the case that it is determined in any of the steps S102, S104 or S106 that no sufficient number of receivers 10 is available, an error message can be output.

Based on the above exemplary embodiments, the aircraft turbine 2 has been described by way of example with a device 1, 1′, 1″. However, the aircraft turbine 2 can also comprise more than one device 1, 1′, 1″, in particular one device 1, 1′, 1″ per shaft 20, 21 and/or one device 1, 1′, 1″ at every bearing 200, 201, 210, 211.

### PARTS LIST

1, 1′, 1″ device
10, 10′ receiver
100 lens
101 optical sensor
11 punched disc (pattern carrier)
11′ pattern carrier
110 hole (pattern site)
12 analysis unit
13 display unit
14, 14′ transmitting unit
140 light source
15 anti-fogging appliance
150 air nozzle
16 electrical signal line
17 optical waveguide
2 aircraft engine
20 shaft (low-pressure shaft)
200, 201 bearing
21 shaft (high-pressure shaft)
210, 211 bearing
22 housing
23 air inlet
24 compressor
240 low-pressure compressor
241 high-pressure compressor
25 combustion chamber
26 turbine
260 low-pressure turbine
261 high-pressure turbine
27 nozzle
A airflow
B curved line
D rotational direction
φ azimuth angle
φₓ azimuth angle (sample width)
φ_{z} azimuth angle (sample distance)
G straight line
L light rays
M1 first pattern
M2 second pattern
R rotational axis
S1-S3 signal
T time
TL trigger level

1. A device for measuring a rotational movement, in particular a rotational direction, of a rotatable structural component, in particular a shaft, with a receiver and a pattern carrier that has at least two pattern sites and that can be connected or is connected to the rotatable structural component in such a manner that it can be rotated together with the same about a rotational axis with respect to the receiver, so that at least one pattern site can be turned towards the receiver, wherein the receiver is embodied and configured to detect a pattern site that is turned towards it, wherein at least two receivers are provided, with respectively at least one of the pattern sites being turnable towards them, wherein the receivers or the pattern sites are arranged along an angle extending circumferentially about the rotational axis in a manner offset with respect to one another, or are arranged with different offsets along the angle in a manner offset with respect to one another.

2. The device according to claim 1, wherein, amongst themselves, the receivers and the pattern sites are arranged respectively in a direction perpendicular and/or parallel to the rotational axis in a manner offset with respect to one another.

3. The device according to claim 1, wherein the pattern sites are arranged according to a first pattern, and the receivers are arranged according to a second pattern, wherein the first pattern is different from the second pattern.

4. The device according to claim 1, wherein the pattern sites and/or the receivers are arranged along a straight line or along a curved line.

5. The device according to claim 1, wherein respectively at least three pattern sites and at least three receivers are provided, wherein each of the pattern sites can be respectively turned towards at least one of the receivers.

6. The device according to claim 1, wherein the receivers are embodied and configured to detect an information carrier exiting from a pattern site that is turned towards them or interacting with the pattern site, wherein the information carrier is in particular embodied as a radiation, as a mass flow and/or as a sound, in particular as light rays, as an airflow and/or as ultrasound.

7. The device according to claim 6, further having at least one sensor for detecting the information carrier, in particular in the form of an optical sensor, of a mass flow meter, of a manometer, and/or a microphone.

8. The device according to claim 6, further having at least one transmitting unit that is embodied and configured to emit the information carrier, and that in particular comprises at least one light source, air nozzle, and/or sound source.

9. The device according to claim 8, wherein the pattern carrier is arranged between the transmitting unit and the receivers.

10. The device according to claim 1, wherein the pattern carrier is embodied in the form of a punched disc, in particular in the form of a circular disc that is arranged coaxially to the rotational axis, wherein the pattern sites are respectively embodied in the form of a hole in the pattern carrier, and the pattern carrier is made of an optically opaque material.

11. The device according to claim 1, wherein the pattern sites extend through the pattern carrier substantially in parallel to the rotational axis.

12. The device according to claim 1, further having at least one anti-fogging appliance that directs a fluid flow, in particular an airflow, onto at least one of the receivers and/or at least one transmitting unit to avoid any depositing from the surrounding gas on the receiver.

13. A turbomachine, in particular an aircraft engine, with at least one shaft and at least one device according to claim 1.

14. The turbomachine according to claim 13, wherein at least one device is arranged in the area of a bearing site of the shaft.

15. A method for measuring a rotational movement, in particular a rotational direction, of a rotatable structural component, in particular a shaft, with a receiver and a pattern carrier that has at least two pattern sites and that is connected to the rotatable structural component in such a manner that it rotates together with the same about a rotational axis with respect to the receiver, so that the pattern site is periodically turned towards one of the receivers, wherein the receiver detects a pattern site that is turned towards it, wherein at least two receivers are provided, with respectively at least one of the pattern sites being turnable towards them, wherein the receiver or the pattern sites are arranged along an angle extending circumferentially about the rotational axis in a manner offset with respect to one another, or are arranged with a different offset along the angle in a manner offset with respect to one another.
